(19) United States
(12) Patent Application Publication
(10) Pub. No.: US 2008/0175332 A1
(43) Pub. Date: Jul. 24, 2008

(54) WIRELESS COMMUNICATIONS APPARATUS

(75) Inventor: Justin COON, Bristol (GB)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/955,872

(22) Filed: Dec. 13, 2007

(30) Foreign Application Priority Data
Dec. 20, 2006 (GB) 0625443.7

(51) Int. Cl. H04B 7/02

(52) U.S. Cl. 375/267

(57) ABSTRACT

A wireless MIMO communications network establishes channel estimation by means of a channel estimation sequence utilising band hopping in a conventional manner from a first antenna. This can then be detected by legacy SISO devices. A further channel estimation sequence is concurrently transmitted from one or more further antennas, the further channel estimation sequence using a band hopping sequence complementary with the aforementioned band hopping sequence so as to avoid collision therewith. This latter channel estimation sequence can thus be detected by cooperating MIMO receiving equipment to provide opportunities for channel estimation.

The present invention is concerned with wireless communication, and particularly, but not exclusively, with the process of channel estimation in a MIMO channel, such as using ultra wide band (UWB) technology for instance in establishing a personal area network (PAN) or wireless local area network (WLAN).

The ECMA-368 standard is based on the proposal by the former multi-band OFDM Alliance (MBOA) and WiMedia to IEEE 802.15.3a. The UWB spectrum, as defined by the FCC license exempt band for emissions of less than −41.3 dBm/MHz, extends from 3.1 GHz to 10.6 GHz. The ECMA-368 standard divides this 7.5 GHz band into five Band Groups, as set out in table 24 of the ECMA-368 standard, First Edition, which is specifically incorporated by reference. Four of these Band Groups contain three sub-bands of 528 MHz, whereas the fifth Band Group, which occupies the highest frequencies, contains two sub-bands.

In the ECMA-368 Standard, two mechanisms are provided which each support multiple wireless personal area networks (WPANs). The particular issue to be resolved when operating multiple WPANs is to avoid repeated attempts by two devices operating in different networks to use a single band of the communications channel. If two networks inadvertently communicate on the same sub-band, or band hop in a synchronised manner between the same sub-bands, then collisions can be a significant problem.

A first approach is to assign WPANs to operate in different Band Groups. This approach is only effective up to a point, and clearly is limited to the number of available Band Groups. In the case of ECMA-368, five Band Groups are defined, so only five mutually ‘audible’ WLANs can be defined. In an enclosed space, this can be difficult to achieve, and places unacceptable limitations on the utility of the technology, given that it may be used by an inexpert operator.

A second approach is to use different time frequency codes (TFCS) for each unique WPAN. In this way, two or more WPANs can be distinguished within a common Band Group. TFCs operate by dividing each packet into blocks of six OFDM symbols. Each of the OFDM symbols within each block of six is transmitted from a pre-assigned band from within the chosen Band Group. The bands used for each consecutive OFDM symbol are defined by the TFCs. Table 25 in the ECMA-368 Standard defines all of the TFCs used for the five Band Groups. This, again, is incorporated by reference. In this approach, it is possible that two mutually “audible” WLANs or WPANs will momentarily share a common band; however, this will be merely in passing and will be limited by the lack of synchronisation between two WLANs or WPANs.

Performance of the ECMA-368 Standard is maximised through the use of TFCs, by interleaving information bits throughout the blocks of six OFDM symbols to maximise frequency diversity. The TFCs that provide this frequency diversity are known as time-frequency interleaved (TFI) logical channels. However, in certain circumstances it may be preferable to operate each WPAN in the same band at all times, and thus in this case fixed TFCs are also provided—these are termed fixed frequency interleaved (FFI) logical channels.

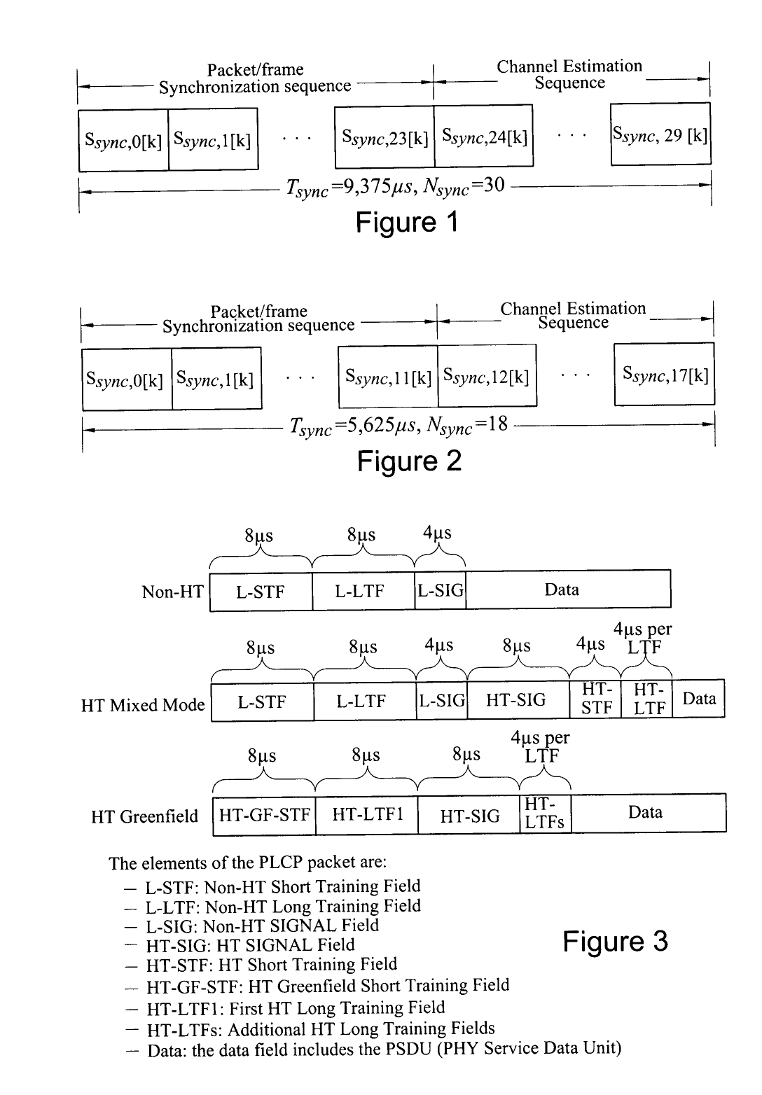

The trade-off of using TFI logical channels is that the preamble must estimate the channel for all three bands of the Band Group, whereas only one band needs to be estimated for FFI logical channels. The channel estimation part of the preamble (FIGS. 1 and 2) comprises six OFDM symbols and therefore the overhead for TFI and FFI logical channels is identical, although the channel estimates for FFI are likely to be better (reduced noise due to more averages) thereby offsetting some of the performance lost due to poorer frequency diversity.

When the TFI approach is employed, the receiver must be able to estimate the channel frequency response for each band in the current Band Group. In the legacy ECMA system, this task is facilitated by the inclusion of a preamble in each transmitted packet. The preambles are arranged in two sections: a packet/frame synchronisation sequence and a channel estimation sequence.

This invention is only concerned with the channel estimation portion of the sequence. FIG. 1 shows the structure of the standard physical (PHY) layer convergence protocol (PLCP) preamble used in the ECMA 368 standard. An alternative PLCP preamble used in burst mode is shown in FIG. 2. The burst mode preamble is only used for streaming applications, where a burst of packets is transmitted with each one separated by a packet minimum inter-frame separation (pMIFS). The active preamble type is signified in the PHY header. As illustrated in FIGS. 1 and 2, the channel estimation portion of the preamble consists of six OFDM symbols (one TFC frame). Consequently, when one of the multi-band TFCs is used, the channel can be estimated twice for each of the three bands. This factor-two redundancy simply ensures that the channel estimate is robust; in fact, each channel need only be estimated once in order for the rest of the communication system to work properly.

The ECMA-368 preambles are designed for UWB systems that use only a single antenna at the transmitter and the receiver. However, given developments in other fields, it is likely that multiple-input multiple-output (MIMO) extensions to the ECMA standard will ensue, to increase the data rate and range. A disadvantage of MIMO transmission is that the MIMO channel matrix must be estimated, which has a dimensionality of M×N×F compared to F of a single-antenna system, where M and N are the numbers of transmit and receive antennas, and F is the number of sub-carriers that are used to carry data, pilot information or guard tones. It is thus desirable to take account of this added complexity in considering the expansion of technology into the MIMO field.

A related problem has been solved in the latest draft of the IEEE 802.11n wireless local area network (WLAN) standard, which is a MIMO extension to the single antenna IEEE 802.11a standard. The preamble designs currently adopted for IEEE 802.11n are shown in FIG. 3. Two options are specified depending on whether the WLAN contains all IEEE 802.11n devices (Greenfield) or whether legacy support is required (Mixed Mode). FIG. 3 also shows the legacy preamble (marked “Non-HT”) for comparison.

The ECMA-368 preambles are not suitable for a MIMO system and the IEEE 802.11n preambles are not designed to operate with a system that uses band hopping defined by TFCs for each piconet supported. It is thus desirable to seek a technology which achieves MIMO UWB channel estimation support using a transmission strategy that is more efficient than is achieved with the IEEE 802.11n system.

In general terms, an aspect of the invention provides a wireless MIMO communications network establishes channel estimation by means of a channel estimation sequence utilising band hopping in a conventional manner from a first antenna. This can then be detected by legacy SISO devices. A further channel estimation sequence is concurrently transmitted from one or more further antennas, the further channel estimation sequence using a band hopping sequence complementary with the aforementioned band hopping sequence so as to avoid collision therewith. This latter channel estimation sequence can thus be detected by cooperating MIMO receiving equipment to provide opportunities for channel estimation.

In the above, the term complementary is intended to include any band hopping sequence which provides no instances wherein two such band hopping sequences share a band of the channel in question. the skilled reader will understand that the choice of suitable complementary band hopping sequences will depend on the nature of the first band hopping sequence, and the number of bands defined in the channel through which a band hopping sequence can proceed.

According to an aspect of the invention, there is provided a method of determining channel estimates in a wireless MIMO communications system, in which a channel estimation sequence frame is reserved for transmission of channel estimation symbols by a multi antenna transmitter and for reception thereof by a multi antenna receiver, the method comprising transmitting in a first symbol period a channel estimation symbol from a first antenna of the transmitter in a first band of a first band hopping sequence and thereafter, in subsequent symbol periods, sequentially transmitting a channel estimation symbol from the first antenna at further bands in accordance with the first band hopping sequence, transmitting in the first symbol period a channel estimation symbol at a second antenna of the transmitter in a first band of a second band hopping sequence and thereafter, in subsequent symbol periods, sequentially transmitting a channel estimation symbol from the second antenna at frequency bands in accordance with the second band hopping sequence, wherein the second band hopping sequence is complementary with the first band hopping sequence, receiving at a first antenna of the receiver in the first symbol period the channel estimation symbol transmitted in the first band of the first band hopping sequence, thereafter receiving at the first antenna subsequently transmitted symbols in accordance with the first band hopping sequence, receiving at a second antenna of the receiver in the first symbol period the channel estimation symbol transmitted in the first band of the second band hopping sequence, thereafter receiving at the second antenna subsequently transmitted symbols in accordance with the second band hopping sequence, wherein the two concurrent transmitting steps are repeated through an iteration of the respective band hopping sequence, and receiving at an antenna of the receiver other than the first antenna in the first symbol period the channel estimation symbol transmitted in the first band of the second iteration of the first band hopping sequence, thereafter receiving at said antenna other than said first antenna subsequently transmitted symbols in accordance with the first band hopping sequence, and receiving at an antenna of the receiver other than the second antenna of the receiver in the first symbol period the channel estimation symbol transmitted in the first band of the second iteration of the second band hopping sequence, thereafter receiving at said antenna other than the second antenna subsequently transmitted symbols in accordance with the second band hopping sequence.

The invention can also be characterised by way of a computer implemented apparatus, such as a general purpose communications device configured by means of a software product. Such a software product can be in the form of an optical or magnetic carrier, or a downloaded computer program to cause configuration of communications devices to operate in accordance with the method of the invention.

Specific embodiments of the invention will now be described by way of example only, with reference to the accompanying drawings, in which:

FIG. 1 is a frame timing diagram illustrating an extract of the ECMA 368 transmission preamble;

FIG. 2 is a frame timing diagram illustrating a further extract of the ECMA 368 transmission preamble;

FIG. 3 is a diagram illustrating frames constructed in accordance with certain profiles of the IEEE 802.11n Standard;

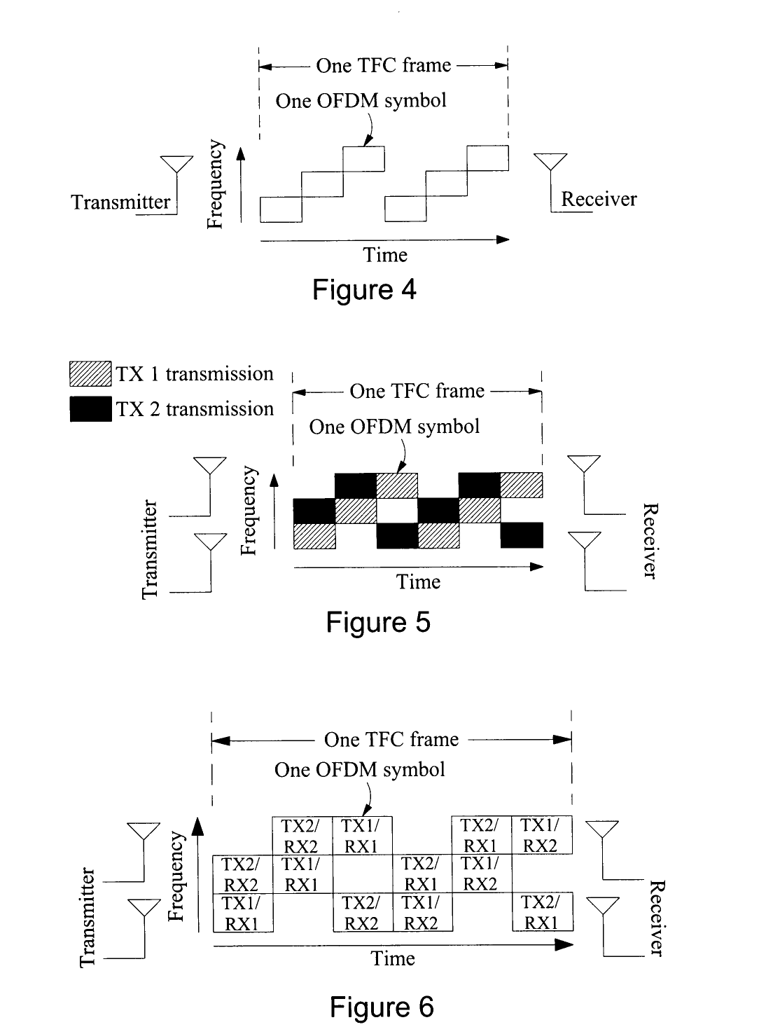

FIG. 4 is an illustration of a TFC frame showing transmission of a channel extraction preamble in accordance with a prior art example;

FIG. 5 is an illustration of a TFC frame showing transmission of a channel extraction preamble in accordance with a first specific embodiment of the invention;

FIG. 6 is an illustration corresponding to FIG. 5 and illustrating operation of a corresponding receiver;

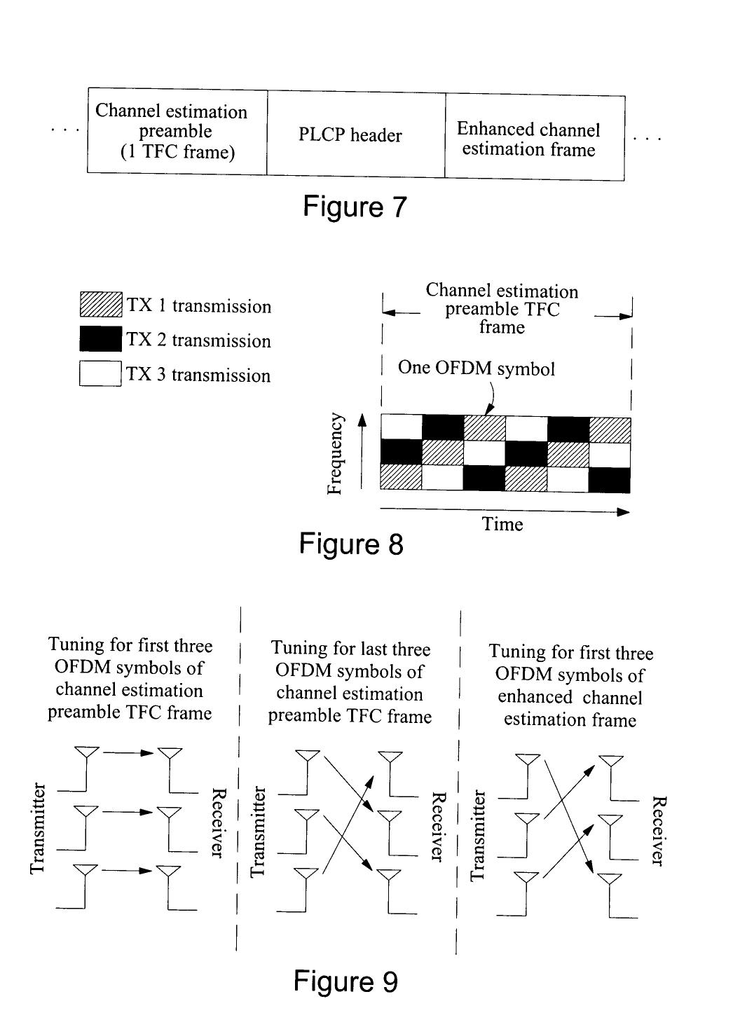

FIG. 7 illustrates a portion of a packet structure in accordance with an embodiment of the invention;

FIG. 8 illustrates a TFC frame showing transmission of a channel extraction preamble in accordance with a second specific embodiment of the invention;

FIG. 9 illustrates timing diagrams to show operation of a cooperating receiver in accordance with the second specific embodiment;

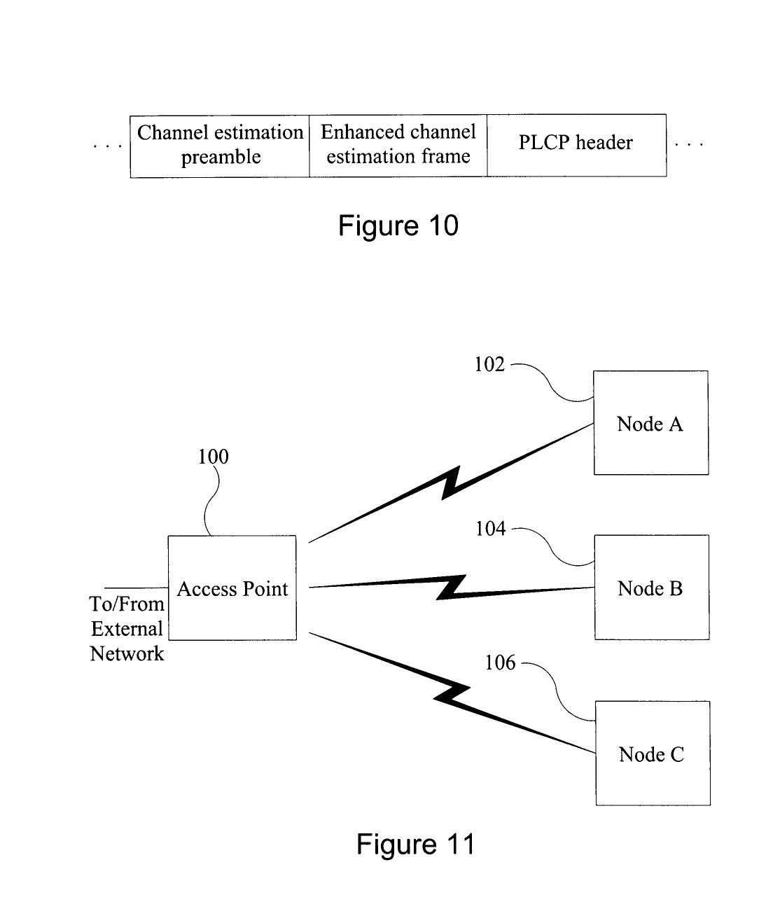

FIG. 10 illustrates a variant on the portion of the packet structure illustrated in FIG. 7;

FIG. 11 is a schematic diagram of a wireless network in which the specific embodiment of the invention is implemented; and

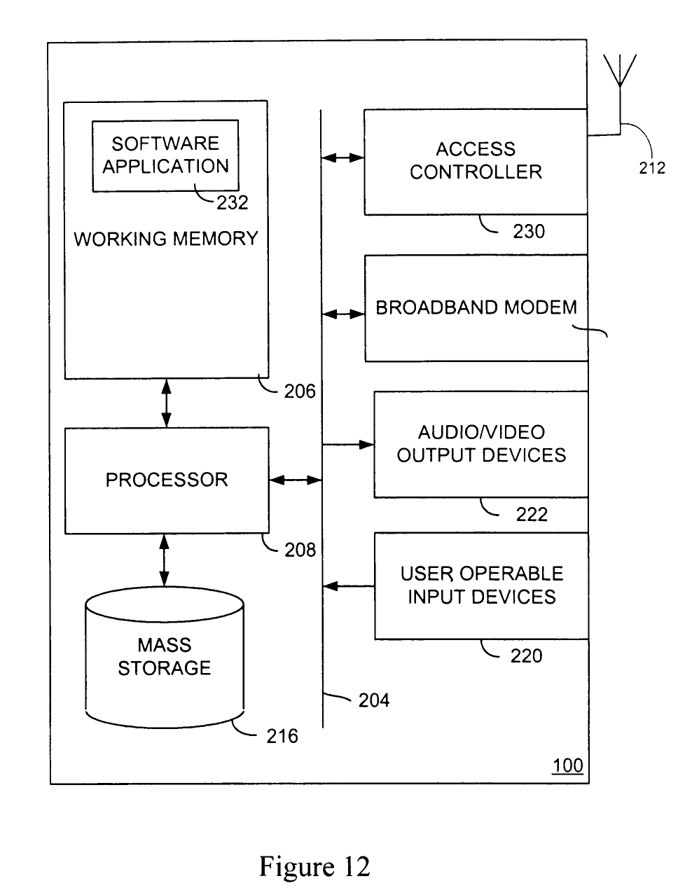

FIG. 12 is a schematic diagram of an access controller illustrated in the wireless network of FIG. 11.

As related previously, the illustrated specific embodiments of the invention are concerned with MIMO Channel Estimation using one TFC Frame and TFI logical channels. MIMO channel estimation cannot be performed by using just one TFC frame and the ECMA preambles when ‘legacy system support’ is required. Legacy ECMA systems (i.e. single-antenna systems modelled on the ECMA-368 standard) can only be supported when the ECMA preamble is transmitted from just one antenna over the bands corresponding to the chosen TFC.

FIG. 4 illustrates an exemplary band hopping scheme applied to a legacy three-subband channel—the legacy single antenna receiver is, on receipt of a particular TFI code, attuned to expect band hopping to take place and will thus monitor the three subbands in the expected order (see FIG. 4). In this case, the legacy system uses this preamble to estimate the channel for all three bands in the Band Group, and then decodes the header to determine whether or not the remainder of the packet is intended for that legacy device. Consequently, even if a MIMO system intends to transmit to another MIMO system, it must adhere to the ECMA-368 standard so that any legacy devices that are listening will not fail and, as a result, cause interference or enter an error state.

One solution to the problem of MIMO channel estimation with legacy system support, and a specific embodiment of this invention, is to transmit from only one transmit antenna on the bands corresponding to the current ECMA-368 TFCs. At the same time, the other two bands are open for transmission and reception. Thus, the other antenna(s) can transmit a preamble on any subset of these bands. In the following, this strategy is illustrated with an example (M=2 transmit antennas and N=2 receive antennas). It will subsequently be generalised to all MIMO antenna configurations, to demonstrate the possibility of broad application of the present invention.

In a first example, a MIMO system is provided comprising a transmitter having two transmit antennas and a receiver having two receive antennas, as illustrated in FIG. 5. In order to adhere to the conditions for legacy support, the ECMA-368 preamble must be transmitted from one of the antennas on the TFC that is specified. TFC 1 from the ECMA-368 Standard is chosen arbitrarily here, by way of example. This TFC can be cyclically shifted and used by the second transmit antenna for the other half of MIMO channel estimation. The resulting TFC in this example is 2,3,1,2,3,1, which is not a TFC defined in the ECMA-368 standard and, thus, will not cause compatibility issues with legacy devices (no device will be synchronised with the second antenna's transmission). This transmission strategy is illustrated in FIG. 5. The hashed blocks indicate transmission of channel estimation symbols by the first antenna in a TFC sequence specified as 1,2,3,1,2,3, while the blacked-out blocks indicate the transmission at the second antenna of channel estimation symbols in the indicated 2,3,1,2,3,1 sequence. Bands are labelled on the vertical axis as 1, 2 and 3, with band 1 indicated on the lowest row, band 2 directly above, and band 3 the uppermost row.

Note that any other non-standard TFC that does not overlap with the chosen legacy TFC can be employed as well, such as 3,1,2,3,1,2.

This therefore supports legacy devices, which will only ‘listen’ to the 1,2,3,1,2,3 synchronisation. The embodiment then provides the opportunity for the MIMO channel to be estimated for the non-legacy MIMO device. To do this, advantage is taken of the fact that the TFCs related to TFI transmission carry redundancy over the bands. For example, TFC 1 specifies transmission on the three bands sequentially for three OFDM symbols, after which the same sequential transmission pattern is repeated to complete the TFC frame. This fact can be used to support MIMO transmission in this example. Referring to FIG. 6, it will be seen that, for the first three OFDM symbols of the six-symbol channel estimation preamble, transmitter one (TX1) and receiver one (RX1) are tuned to the same band and transmitter two (TX2) and receiver two (RX2) are tuned to the same band, which is different from the one to which the first transmit/receiver pair (TX1/RX1) are tuned. During the last three OFDM symbols, transmitter one (TX1) and receiver two (RX2) are tuned to the same band and transmitter two (TX2) and receiver one (RX1) are tuned to the other band. Thus, by the end of the TFC frame, all four channel paths (2×2) have been estimated for all three bands.

It is useful to generalise the above case to exemplify the wide application of the present invention. In order to generalise the example above to systems with M transmit antennas and N receive antennas, several rules or constraints on the transmission strategy must first be outlined. These rules follow from two simple principles: 1) legacy systems must be supported, and 2) all MIMO channels must be estimated over the course of one TFC frame. The specific rules related to this preamble transmission strategy are as follows:
Transmitter one (or at least, one of the transmitters) must always follow a TFC specified in the ECMA-368 standard;
All other transmitters must not transmit on the same band as transmitter one so as not to destroy legacy system support;
At least one receiver should be tuned to each transmitter at all times;
All MIMO channel paths for all three bands must be estimated by the end of the TFC frame.

It will be understood that the term ‘transmitter one’ is not specific to a particular transmitter in a system; the labelling convention is arbitrary.

Using the aforementioned rules, the generalisation can be written as follows:

Let M be the number of transmit antennas and N be the number of receive antennas. Let Φ denote the set of all receive antennas, and let Φₗ⊂Φ for l=1, 2, . . . , M be the sets of receive antennas that are tuned to the M transmit antennas. The union of these subsets is the full set

$$( i . e . {⋃}_{l} {Φ}_{l} = Φ ) .$$

Also, the first set and all other sets are mutually exclusive (i.e. Φ₁∩Φₗ=Ø, ∀l>1).

For TFCs 1 and 2 (see ECMA-368 Standard), transmitter one and the receivers in Φ₁ are tuned to the same band (specified by the TFC) for the first three OFDM symbols, and transmitter m (for m>1) and the receivers in Φₘ are tuned to the same band (different from the band used by transmitter one) for the same three OFDM symbols. During these three OFDM symbol periods, all transmissions must cycle over all three bands in the Band Group. During the last three OFDM symbols in the TFC frame, transmitter one and the receivers in [symbol] Φₗ are tuned to the same band (identical to the band used by transmitter one for transmission of the first three OFDM symbols). Transmitter m (for m>1) and the receivers in Φ₁ are tuned to the same band (different from the band used by transmitter one) for the same three OFDM symbols. It can easily be verified that it is only possible to estimate all channels for all three bands when Φ₂=Φ₃= . . . =Φ_{M}. It will be understood that the indexing notation used here is arbitrary. Also, the method described above is reversible, i.e., transmitter one and the receivers in [symbol] Φₗ may be tuned to the same band during the first three OFDM symbol periods; the rest of this reciprocal algorithm follows directly.

For TFCs 3 and 4 (see ECMA-368 Standard), transmitter one and the receivers in Φ₁ are tuned to the same band (specified by the TFC) during odd-numbered OFDM symbols in a TFC frame (indexed from one to six), and transmitter m (for m>1) and the receivers in Φₘ are tuned to the same band (different from the band used by transmitter one) for the same OFDM symbol periods. During these three OFDM symbol periods, all transmissions must cycle over all three bands in the Band Group. During the even numbered OFDM symbols in the TFC frame, transmitter one and the receivers in [symbol] Φₗ are tuned to the same band (identical to the band used by transmitter one for transmission of the odd-numbered OFDM symbols). Transmitter m (for m>1) and the receivers in Φ₁ are tuned to the same band (different from the band used by transmitter one) for the same three OFDM symbol periods. It is only possible to estimate all channels for all three bands when Φ₂=Φ₃= . . . =Φ_{M}. It will be understood that the indexing notation used here is arbitrary. Also, the method described above is reversible, i.e., transmitter one and the receivers in [symbol] Φₗ may be tuned to the same band during the three odd-numbered OFDM symbol periods; the rest of this reciprocal algorithm follows directly.

It should be noted that only two bands out of three are transmitted on at any given instant when one of the methods described above is used.

From the discussion above, it is noted that M−1 transmitters must use the same band at the same time to convey preamble (training) sequences to a given set of receivers. This leads to interference amongst transmissions; however, this interference is a common feature of MIMO channel estimation and can be solved by using a number of approaches, such as MIMO least-squares (LS) channel estimation, minimum mean-square error (MMSE) channel estimation, and orthogonal training sequences. Such approaches will be familiar to the skilled reader.

The above example will now be augmented by way of a description of MIMO Channel Estimation Using Multiple TFC Frames and TFI Logical Channels.

The technique mentioned above is optimal for a 2×2 system (as shown in the preceding example) because all channels can be estimated with equal reliability. However, when there are more than two transmit antennas, M−1 of the channel estimation transmissions will interfere with each other since they use the same band to transmit to the same set of receivers, as described above. It was noted previously that this problem can be overcome by using orthogonal preambles in conjunction with LS or MMSE channel estimation algorithms (for example). However, in such cases, the quality of the channel estimate is not as good as when a single transmit antenna has exclusive access to the transmission medium. In this case, the method described above can be used to obtain an initial channel estimate, after which the PLCP header is received and processed by the MIMO and legacy systems. After this processing, a legacy device would recognise that the transmission is not intended for it, and will thus refrain from transmitting for a given period of time (which is specified in the PLCP header). Consequently, the MIMO system is free to use the medium for a further channel estimation transmission to enhance the initial channel estimate that was obtained from the standard preamble TFC frame (see FIG. 7). This enhanced channel estimation frame can be used to improve the quality of any of the MIMO channel estimates, but should most likely be used to improve the estimates of the channels between the M−1 transmit antennas and the receive antennas that utilised orthogonal preamble sequences during the preamble channel estimation TFC frame.

In a specific embodiment of this invention, the number of full TFC frames that are used in the enhanced channel estimation frame is

$$⌈ \frac{M}{2} ⌉ - 1$$

where ┌•┐ denotes the rounding of the argument to the next integer greater than the argument. This is the number of frames required to obtain equally reliable channel estimates for all channels. Alternatively, if partial TFC frames are supported (in fractions of ½), the number of TFC frames that are used can simply be

$$\frac{M}{2} - 1.$$

In another exemplary embodiment, during the channel estimation preamble, all three bands in the Band Group may be used to estimate the channel over the six OFDM symbols, giving a total of 18 time-frequency channels over which channel estimation can be performed. This is only possible when M>2 (for M=2, the optimal case was given above). In this case,

$${Φ}_{k} ⋂ {Φ}_{𝓁} = Ø , ∀ 𝓁 \neq k and {⋃}_{𝓁} {Φ}_{𝓁} = Φ ,$$

and the channel can be estimated as follows:

For TFCs 1 and 2 (q.v. ECMA-368 Standard), transmitter one and the receivers in Φ₁ are tuned to the same band (specified by the TFC) for the first three OFDM symbols of the channel estimation preamble TFC frame, and transmitter m (for m>1) and the receivers in Φₘ are tuned to the same band (different from the band used by transmitter one) for the same three OFDM symbols. During these three OFDM symbol periods, all transmissions must cycle over all three bands in the Band Group. During the last three OFDM symbols in the TFC frame, transmitter one and the receivers in Φ₂ are tuned to the same band (identical to the band used by transmitter one for transmission of the first three OFDM symbols). Transmitter m (for m>1) and the receivers in Φ_{(mmodM)+1} are tuned to the same band (different from the band used by transmitter one) for the same three OFDM symbols. In the enhanced channel estimation frame, each TFC is split into groups of three OFDM symbols. During the nth group (for n=1, 2, . . . ), transmitter one and the receivers in Φ_{((n+1)modM)+1} are tuned to the same band (identical to the band used by transmitter one for transmission during the preamble). Transmitter m (for m>1) and the receivers in Φ((n+m)modM)+1 are tuned to the same band (different from the band used by transmitter one) for the same three OFDM symbols. It will be understood that the indexing notation used here is arbitrary. Also, the steps in the procedure described above can be permuted.

For TFCs 3 and 4 (see ECMA-368 standard), transmitter one and the receivers in Φ₁ are tuned to the same band (specified by the TFC) for the odd-numbered OFDM symbols of the channel estimation preamble TFC frame, and transmitter m (for m>1) and the receivers in Φₘ are tuned to the same band (different from the band used by transmitter one) for the same three OFDM symbols. During these three OFDM symbol periods, all transmissions must cycle over all three bands in the Band Group. During the even-numbered OFDM symbols in the TFC frame, transmitter one and the receivers in Φ₂ are tuned to the same band (identical to the band used by transmitter one for transmission of the first three OFDM symbols). Transmitter m (for m>1) and the receivers in Φ_{(mmodM)>1} are tuned to the same band (different from the band used by transmitter one) for the same three OFDM symbols. In the enhanced channel estimation frame, each TFC is split into groups of three OFDM symbols (odd-numbered and even-numbered). During the nth group (for n=1, 2, . . . ), transmitter one and the receivers in Φ_{((n+1)modM)+1} are tuned to the same band (identical to the band used by transmitter one for transmission during the preamble). Transmitter m (for m>1) and the receivers in Φ_{((n+m)modM)+1} are tuned to the same band (different from the band used by transmitter one) for the same three OFDM symbols. It will be understood that the indexing notation used here is arbitrary. Also, the steps in the procedure described above can be permuted.

An example will now be set out for the case where M=N=3 and TFC 1 is used. Employing the methodology described above, the MIMO channel can be estimated for all three bands in the following manner. During the channel estimation preamble, transmitter one transmits on the TFC bands (1, 2, and 3) sequentially; transmitter two transmits on bands 2, 3, and 1 sequentially; and transmitter three transmits on bands 3, 1, and 2 sequentially as shown in FIG. 8.

During the first three OFDM symbol periods of the preamble TFC frame, receiver one is tuned to transmitter one, receiver two to transmitter two, and receiver three to transmitter three; and during the last three symbol periods of the preamble TFC frame, receiver one is tuned to transmitter three, receiver two to transmitter one, and receiver three to transmitter two. This is shown in FIG. 9. After the PLCP header, an enhanced channel estimation frame is used. The length of this frame (in terms of OFDM symbols) is a multiple of three. For the first three OFDM symbol periods, receiver one is tuned to transmitter two, receiver two to transmitter three, and receiver three to transmitter one, which is illustrated in FIG. 9. Thus, by the end of the first three OFDM symbols of the enhanced channel estimation frame, all MIMO channels have been estimated with equal reliability since orthogonal training sequences were not employed (or needed). However, it is important to note that the enhanced estimation frame could be longer than three OFDM symbols. In this case, the channel estimate could be made to be more robust.

When FFI logical channels are used and legacy support is required, an enhanced channel estimation frame is needed. The channel estimation problem then resembles that of 802.11n-type systems since band hopping is not employed (see FIG. 3).

When legacy support is not required, the MIMO channel can be estimated using any of the methods discussed above, but where the enhanced channel estimation frame is not required to come after the PLCP preamble (see FIG. 10). Also, the MIMO system does not need to use the ECMA-368 TFCs or the ECMA-368 channel estimation preamble sequences.

Conventional ECMA-368 packet structures cannot support MIMO channel estimation at present. Aspects of the present invention provide a method of supporting MIMO channel estimation while remaining backward compatible with current ECMA-368 devices.

Further, aspects of the present invention provide for MIMO channel estimation while supporting legacy devices in the network. Furthermore, the MIMO channel estimate can be obtained in an efficient manner, with very little or no additional overhead.

It will be further recognised that the invention resides in apparatus to achieve channel estimation in the above manner, and a specific embodiment of a system appropriate for the delivery of the invention is illustrated in FIGS. 11 and 12.

A communications network used in an embodiment of the invention is illustrated in FIG. 11. The communications network is a wireless network, with an access point 100 and network node A 102, node B 104 and node C 106. The access point 100 is connected to an external network (such as the Internet), in this example by means of a broadband modem. It will be appreciated that other alternative arrangements can be made for the access point to establish connection to an external source of streaming packet-based data.

The access point 100 establishes wireless communication with nodes A 102, B 104 & C 106. The access point 100 is thus configured to route data between the external network and the respective nodes 102, 104, 106.

In this embodiment, by way of example only, Node A 102 is a portable laptop computer, Node B 104 is a desktop computer and Node C 106 is a multimedia device (e.g. set-top box) operable in conjunction with a television or hi-fi system. Each of these nodes 102, 104, 106 is equipped with multiple antennas and is configured to communicate with the access point 100, which similarly employs multiple antennas.

FIG. 12 shows the structure of access point 100 in an embodiment of the invention. In this embodiment, the access point 100 is equipped with a broadband modem 202 as previously described, to establish connection to the Internet. The broadband modem 202 is connected to a general purpose bus 204, which in turn connects to the components of the access point including working memory (combining RAM and ROM function, as required) 206, a processor 208, a wireless network access controller 230 and a mass storage device 216. The access controller 230 is, in turn, connected to an antenna 212. The working memory 206 includes a software application 230 for controlling the operation of the access point 100. This software application is operable to configure the access point 100 to operate in accordance with the channel estimation scheme described above, in accordance with a specific embodiment of the invention.

User operable input devices 220 are further provided, in communication with the processor 208. The user operable input devices 220 comprise any means by which an input action can be interpreted and converted into data signals.

Audio/video output devices 222 are further connected to the general-purpose bus 204, for the output of information to a user. Audio/video output devices 222 include any device capable of presenting information to a user, for example, a speaker and a video display unit.

The operation of the access point 100 will now be described. On the basis of execution of an application residing at a network node, data is retrieved from the external network via a connection established through the broadband modem 202. The manner in which the modem establishes connection is not relevant to the present invention, and can be of a conventional nature.

The retrieved data is then stored in the RAM 206. The access controller 230, determines, on an ongoing basis, access to the network by the access point 100 and by the other nodes 102, 104, 106. The access controller 230 is operable to send out to other nodes a frame in accordance with the specific embodiment of the invention, as previously described, with a multiple band channel estimation portion including a legacy band hopping scheme and a contemporaneous band hopping scheme operable to provide further channel estimation opportunities, for receipt by the multi-antenna nodes.

Each device thus, in this example, is capable of sending and receiving the channel estimation portion of the frame as previously described. Embodiments of the invention can be considered as the interaction of the receiving facility on one device with the sending facility on another device, or in terms of the combined receiving and sending facilities on a single device.

1. A method of determining channel estimates in a wireless MIMO communications system, in which a channel estimation sequence frame is reserved for transmission of channel estimation symbols by a multi antenna transmitter and for reception thereof by a multi antenna receiver, the method comprising transmitting in a first symbol period a channel estimation symbol from a first antenna of the transmitter in a first band of a first band hopping sequence and thereafter, in subsequent symbol periods, sequentially transmitting a channel estimation symbol from said first antenna at further bands in accordance with the first band hopping sequence,
transmitting in the first symbol period a channel estimation symbol at a second antenna of the transmitter in a first band of a second band hopping sequence and thereafter, in subsequent symbol periods, sequentially transmitting a channel estimation symbol from said second antenna, at frequency bands in accordance with the second band hopping sequence, wherein the second band hopping sequence is complementary with the first band hopping sequence,
receiving at a first antenna of the receiver in the first symbol period the channel estimation symbol transmitted in the first band of the first band hopping sequence, thereafter receiving at the first antenna subsequently transmitted symbols in accordance with the first band hopping sequence,
receiving at a second antenna of the receiver in the first symbol period the channel estimation symbol transmitted in the first band of the second band hopping sequence, thereafter receiving at the second antenna subsequently transmitted symbols in accordance with the second band hopping sequence,
wherein the two concurrent transmitting steps are repeated through an iteration of the respective band hopping sequence, and
receiving at an antenna of the receiver other than the first antenna in the first symbol period of the second iteration of the first band hopping sequence the channel estimation symbol transmitted in the first band, thereafter receiving at said antenna other than said first antenna subsequently transmitted symbols in accordance with the first band hopping sequence, and
receiving at an antenna of the receiver other than the second antenna of the receiver in the first symbol period of the second iteration of the second band hopping sequence the channel estimation symbol transmitted in the first band, thereafter receiving at said antenna other than the second antenna subsequently transmitted symbols in accordance with the second band hopping sequence.

2. A method in accordance with claim 1 wherein the step of receiving at an antenna of the receiver other than the first antenna comprises receiving at the second antenna of the receiver.

3. A method in accordance with claim 1 wherein the step of receiving at an antenna other than the second antenna comprises receiving at the first antenna of the receiver.

4. A method in accordance with claim 1 wherein the first band hopping sequence comprises a three hop sequence between three bands defined in the channel.

5. A method in accordance with claim 4 wherein the second band hopping sequence comprises a three hop sequence between the three bands, the second band hopping sequence being non coincident with the first band hopping sequence.

6. A method in accordance with claim 1 wherein the transmitter comprises more than two antennas, and including transmitting in the first symbol period a channel estimation symbol at the or each further antenna of the transmitter in a first band of a third band hopping sequence and thereafter, in subsequent symbol periods,
sequentially transmitting a channel estimation symbol from the or each further antenna of the transmitter at frequency bands in accordance with the third band hopping sequence, wherein the third band hopping sequence is complementary with the first and second band hopping sequences.

7. A method in accordance with claim 1 wherein the transmitter comprises more than two antennas, and including transmitting in the first symbol period a channel estimation symbol at the or each further antenna of the transmitter the same symbol as transmitted at the second antenna and thereafter, in subsequent symbol periods, sequentially transmitting a channel estimation symbol from the or each further antenna of the transmitter at frequency bands in accordance with the second band hopping sequence.

8. A method in accordance with claim 1 and including the step of transmitting additional iterations of the channel estimation sequences in a data portion of a transmission frame, for receipt and determination by a MIMO receiver.

9. A wireless MIMO communications network comprising a transmitter and a receiver, each having first and second antennas, the transmitter being operable to transmit a channel estimation sequence frame for determination of channel estimates, the transmitter being operable to transmit, in a first symbol period, a channel estimation symbol from the first antenna of the transmitter in a first band of a first band hopping sequence and thereafter, in subsequent symbol periods, to sequentially transmit a channel estimation symbol from said first antenna at further bands in accordance with the first band hopping sequence,
the transmitter being further operable to transmit in the first symbol period a channel estimation symbol at the second antenna in a first band of a second band hopping sequence and thereafter, in subsequent symbol periods, sequentially transmitting a channel estimation symbol from said second antenna, at frequency bands in accordance with the second band hopping sequence, wherein the second band hopping sequence is complementary with the first band hopping sequence,
the receiver being operable to receive at the first antenna of the receiver in the first symbol period the channel estimation symbol transmitted in the first band of the first band hopping sequence, thereafter being operable to receive at the first antenna subsequently transmitted symbols in accordance with the first band hopping sequence,
the receiver being further operable to receive at the second antenna of the receiver in the first symbol period the channel estimation symbol transmitted in the first band of the second band hopping sequence, thereafter being operable to receive at the second antenna subsequently transmitted symbols in accordance with the second band hopping sequence,
the transmitter being operable to repeat the two transmission operations through the respective band hopping sequences, and
wherein the receiver is operable to receive at an antenna of the receiver other than the first antenna, in the first symbol period of the second iteration of the first band hopping sequence, the channel estimation symbol transmitted in the first band, thereafter being operable to receive at said antenna other than said first antenna subsequently transmitted symbols in accordance with the first band hopping sequence, and
wherein the receiver is operable to receive at an antenna of the receiver other than the second antenna of the receiver, in the first symbol period of the second iteration of the second band hopping sequence, the channel estimation symbol transmitted in the first band, thereafter being operable to receive at said antenna other than the second antenna subsequently transmitted symbols in accordance with the second band hopping sequence.

10. A communications apparatus comprising transmitting means and receiving means, and first and second antennas, the transmitting means being operable to transmit a channel estimation sequence frame for determination of channel estimates in conjunction with another communications apparatus, the transmitting means being operable to transmit, in a first symbol period, a channel estimation symbol from the first antenna in a first band of a first band hopping sequence and thereafter, in subsequent symbol periods, to sequentially transmit a channel estimation symbol from said first antenna at further bands in accordance with the first band hopping sequence,
the transmitting means being further operable to transmit in the first symbol period a channel estimation symbol at the second antenna in a first band of a second band hopping sequence and thereafter, in subsequent symbol periods, to sequentially transmit a channel estimation symbol from said second antenna, at frequency bands in accordance with the second band hopping sequence, wherein the second band hopping sequence is complementary with the first band hopping sequence,
the transmitter being operable to repeat the two transmission operations through the respective band hopping sequences,
the receiver being operable to receive at the first antenna in a first symbol period, a channel estimation symbol transmitted by a cooperating apparatus in a first band of a first band hopping sequence, thereafter being operable to receive at the first antenna subsequently transmitted symbols in accordance with the first band hopping sequence,
the receiver being further operable to receive at the second antenna of the receiver in the first symbol period a channel estimation symbol transmitted in the first band of the second band hopping sequence by another apparatus, thereafter being operable to receive at the second antenna subsequently transmitted symbols in accordance with the second band hopping sequence, the receiving means being operable to expect repetition of the two transmission operations at another apparatus through the respective band hopping sequences, and
wherein the receiver is operable to receive at an antenna of the receiver other than the first antenna, in the first symbol period of a second iteration of the first band hopping sequence, the channel estimation symbol transmitted in the first band, thereafter being operable to receive at said antenna other than said first antenna subsequently transmitted symbols in accordance with the first band hopping sequence, and
wherein the receiver is operable to receive at an antenna of the receiver other than the second antenna of the receiver, in the first symbol period of the second iteration of the second band hopping sequence, the channel estimation symbol transmitted in the first band, thereafter being operable to receive at said antenna other than the second antenna subsequently transmitted symbols in accordance with the second band hopping sequence.

11. A computer program product operable to configure a general purpose computerised communications device as apparatus as set out in claim 10.
